(19) United States
(12) Patent Application Publication
(10) Pub. No.: US 2006/0228600 A1
(43) Pub. Date: Oct. 12, 2006

(54) Fuel cell unit and method of measuring remaining amount of fuel

(75) Inventors: Akihiro Ozeki, Ome-shi (JP); Ryoichi Sebori, Fussa-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/370,968

(22) Filed: Mar. 8, 2006

(30) Foreign Application Priority Data
Apr. 12, 2005 (JP) 2005-114793

(51) Int. Cl. H01M 8/04

(52) U.S. Cl. 429/22; 429/26; 429/34; 429/13

(57) ABSTRACT

According to one embodiment, a remaining amount of the fuel is calculated on the basis of the new feed amount information by the temperature sensors/liquid amount sensors/voltage monitors, and the new feed amount information is stored in EEPROM to update previous feed amount information with the new feed amount information.

### CROSS-REFERENCE TO RELATED APPLICATIONS

This application is based upon and claims the benefit of priority from Japanese Patent Application No. 2005-114793, filed Apr. 12, 2005, the entire contents of which are incorporated herein by reference.

### BACKGROUND

1. Field

One embodiment of the invention relates to a fuel cell unit in, for example, a direct methanol type and a method of measuring a remaining amount of fuel.

2. Description of the Related Art

There are various types of fuel cells and a direct methanol fuel cell (DMFC) is suitable for an information processing apparatus. The fuel cell of this type employs a dilution and circulation system. A methanol solution of low concentration is circulated in the system. Highly concentrated methanol is refilled for consumption of methanol caused by power generation and water generated by a chemical reaction is recovered and refilled for consumption of water. For this reason, the fuel cell comprises a mixing tank in which high-concentration methanol and water to be refilled are mixed to generate a methanol solution.

The high-concentration methanol is refilled in a fuel cartridge provided inside the information processing apparatus. Detection of a remaining amount of fuel in the fuel cartridge improves usefulness of the fuel cell. A method of detecting a remaining amount of fuel in a fuel cartridge is a technique of estimating the remaining amount of fuel from a remaining sensor and variation in the power generation, for example, if the fuel cartridge does not have a function of detecting the remaining amount (Jpn. Pat. Appln. KOKAI Publication No. 2004-288574).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an outer appearance of a fuel cell unit according to a first embodiment of the invention;

FIG. 2 shows an outer appearance of an information processing apparatus connected to the fuel cell unit according to the first embodiment;

FIG. 3 shows a structure of a power generation unit in the fuel cell unit according to the first embodiment;

FIG. 4 shows connection of the information processing apparatus to the fuel cell unit according to the first embodiment;

FIG. 5 shows the structure of the fuel cell unit and the structure of the information processing apparatus according to the first embodiment;

FIG. 6 shows change of states in the fuel cell unit and the information processing apparatus according to the first embodiment;

FIG. 7 shows a flowchart of a processing for detecting a remaining amount of fuel according to the first embodiment;

FIG. 8 shows a table of main control commands for the fuel cell unit according to the first embodiment;

FIG. 9 shows a table of main power supply information of the fuel cell unit according to the first embodiment;

FIG. 10 shows a graph indicating variation in a feed amount of the fuel feed pump in accordance with the pressure thereof according to the first embodiment;

FIG. 11 shows a graph indicating variation in an inner pressure in accordance with the remaining amount of fuel in the fuel cartridge according to the first embodiment; and

FIG. 12 shows a graph indicating correction of characteristics of the fuel cartridge according to a second embodiment of the invention.

### DETAILED DESCRIPTION

Various embodiments according to the invention will be described hereinafter with reference to the accompanying drawings. In general, according to one embodiment of the invention, a fuel cell unit comprising a fuel cell, fuel containing means for containing a fuel, a mixture tank in which water obtained by condensing steam fed from the fuel cell and the fuel fed from the fuel containing means are mixed and a fuel solution to be supplied to the fuel cell is generated, storage means for storing first feed amount information of the fuel fed from the fuel containing means to the mixture tank, fuel feeding means for feeding the fuel from the fuel containing means to the mixture tank, on the basis of the first feed amount information, measuring means connected to the fuel feeding means, for measuring a feed operation amount of the fuel feeding means until the fuel is out, a first channel which refluxes the fuel solution between the mixture tank and the fuel cell, a control unit for calculating remaining amount information of the fuel in the fuel feeding means and second feed amount information on the basis of the feed operation amount obtained from a measurement result of the measuring means, and a controller for updating the first feed amount information stored in the storage means with the second feed information.

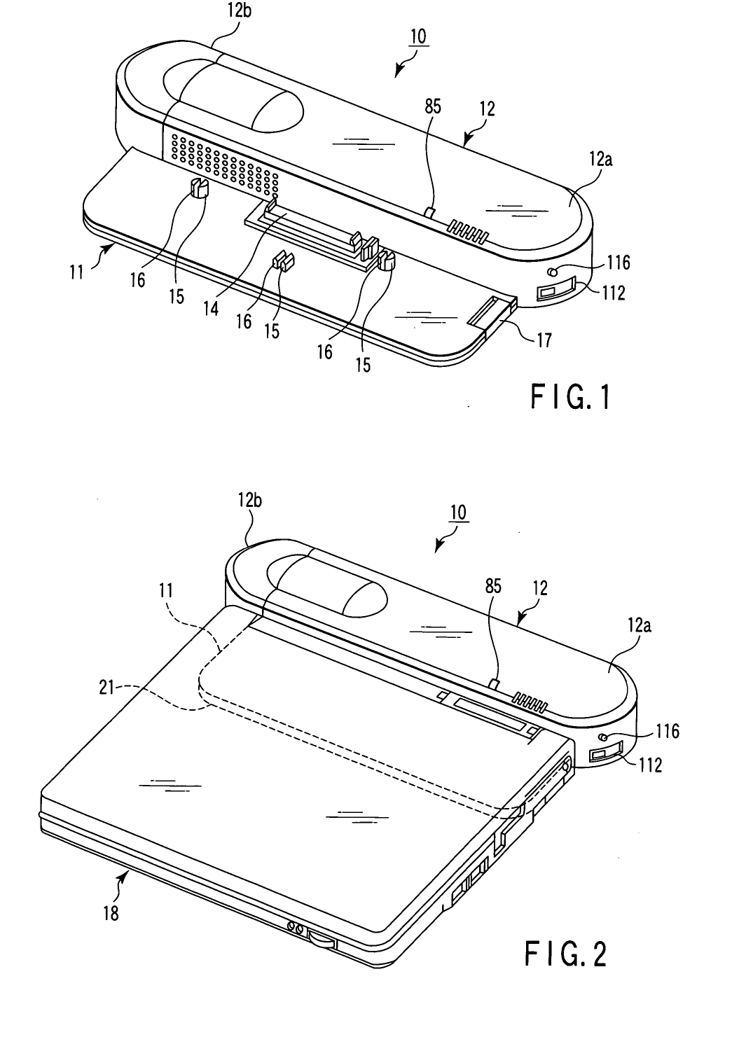

According to an embodiment, FIG. 1 shows an outer appearance of a fuel cell unit according to the embodiment of the present invention. The fuel cell unit 10 is composed of a mounting portion 11 on which an information processing apparatus, for example, notebook-size personal computer is mounted, and a fuel cell unit body 12. The fuel cell unit body 12 includes a DMFC stack which generates electric power by an electrochemical reaction, and auxiliary machines (pumps, valves, etc.) which supply methanol and air as a fuel to the DMFC stack and circulate them.

In addition, a detachable fuel cartridge (not shown) is provided on, for example, a left end inside a unit case 12a of the fuel cell unit body 12. A cover 12b is detachably provided to facilitate exchange of the fuel cartridge.

The information processing apparatus is mounted on the mounting portion 11. A docking connector 14 serving as a connecting portion to connect to the information processing apparatus is provided on a top surface of the mounting portion 11. On the other hand, a docking connector 21 (not shown) serving as a connecting portion to connect to the fuel cell unit 10 is provided on, for example, a rear bottom portion of the information processing apparatus. The docking connector 21 is mechanically and electrically connected with the docking connector 14 of the fuel cell unit 10. Positioning protrusions 15 and hooks 16 are provided at three positions on the mounting portion 11. The positioning protrusions 15 and hooks 16 are inserted into three holes that are formed on the rear bottom portion of the information processing apparatus to correspond to the positioning protrusions 15 and hooks 16.

When the information processing apparatus is detached from the fuel cell unit 10, a lock mechanism (not shown) is released by pushing an eject button 17 of the fuel cell unit 10 shown in FIG. 2. The information processing apparatus can be thereby detached easily.

A power generation setting switch 112 and a fuel cell operation switch 116 are provided on, for example, a right side surface of the fuel cell unit body 12.

The power generation setting switch 112 is preset by a user to permit or prohibit power generation in the fuel cell unit 10. The power generation setting switch 112 is composed of, for example, a slide-type switch.

The fuel cell operation switch 116 is used in a case where, for example, when an information processing apparatus 18 is operated with the electric power generated by the fuel cell unit 10, power generation in the fuel cell unit 10 needs to be stopped while the operation of the information processing apparatus 18 is continued. In this case, the operation of the information processing apparatus 18 is continued with electric power of a secondary cell built in the information processing apparatus 18. The fuel cell operation switch 116 is composed of, for example, a push switch or the like.

An indicator lamp 85 such as a LED (light-emitting diode) or the like which, for example, emits a green light at the operation of the fuel cell unit body 12 or a red light at an abnormal time is provided on, for example, a top surface of the fuel cell unit body 12.

FIG. 2 shows an outer appearance of the information processing apparatus 18 (for example, notebook-size personal computer) placed on the mounting portion 11 of the fuel cell unit 10 and connected thereto.

Various shapes and sizes of the fuel cell unit 10 shown in FIG. 1 and FIG. 2 and various shapes and positions of the docking connector 14 can be conceived.

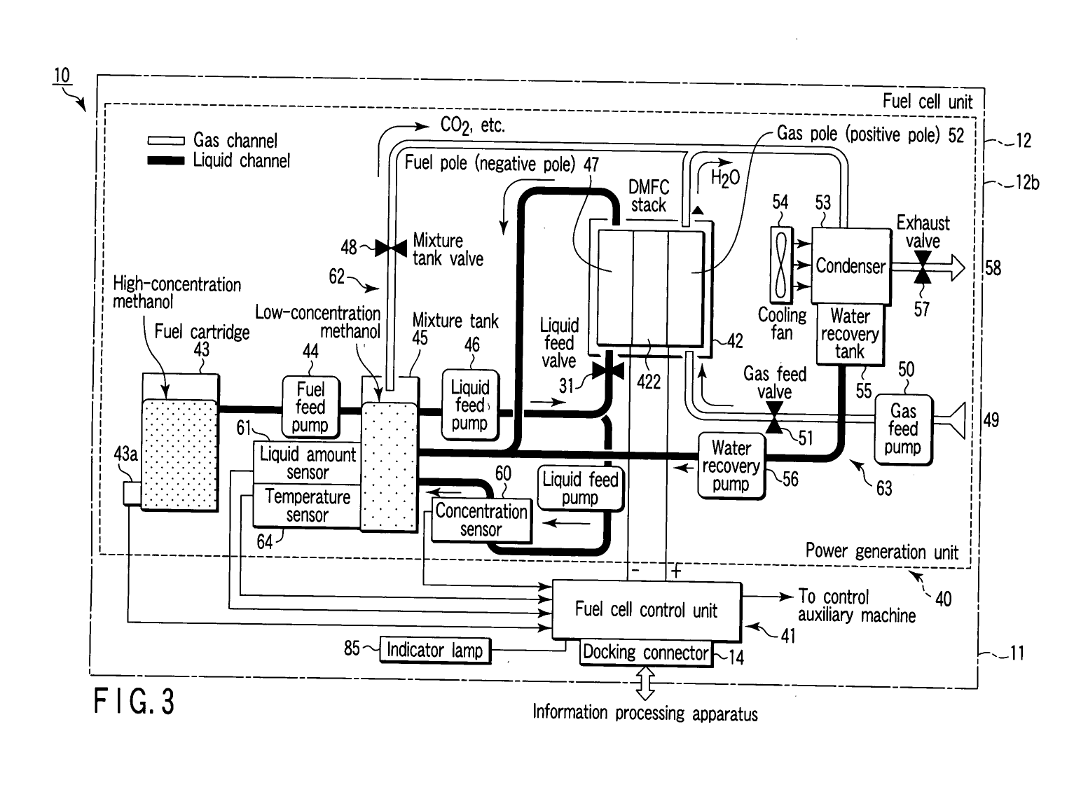

FIG. 3 shows a system of the fuel cell unit 10 and, particularly, details of the DMFC stack and auxiliary machines provided in the vicinity of the DMFC stack.

The fuel cell unit 10 comprises a power generation unit 40 and a fuel cell control unit 41 serving as a control unit of the fuel cell unit 10. Besides a function of controlling the power generation unit 40, the fuel cell control unit 41 has a function of serving as a communication control unit which makes communications with the information processing apparatus 18.

The power generation unit 40 comprises a DMFC stack 42 for power generation and a fuel cartridge 43 serving as a fuel containing means which contains methanol. Highly concentrated methanol is sealed in the fuel cartridge 43. The fuel cartridge 43 can be detached can easily be exchanged when the fuel is consumed.

In general, occurrence of crossover phenomenon needs to be reduced to improve efficiency of power generation in the direct methanol fuel cell. For this reason, it is effective to dilute high-concentration methanol and inject low-concentration methanol obtained by the dilution into a fuel pole 47. To implement this, the fuel cell unit 10 employs a dilution and circulation system 62. An accessory machine 63 is provided in the power generation unit 40 for implementation of the dilution and circulation system 62.

The auxiliary machine 63 is provided in liquid channels and gas channels.

In one of the liquid channels, a fuel feed pump 44 serving as a fuel feed means is connected to an output unit of the fuel cartridge 43. An output unit of the fuel feed pump 44 is connected to a mixture tank 45. An output unit of the mixture tank 45 is connected to a liquid feed pump 46. An output unit of the liquid feed pump 46 is connected to a fuel pole 47 of the DMFC stack 42 via a liquid feed valve 31. An output unit of the fuel pole 47 is connected to the mixture tank 45. Thus, the liquid channel which refluxes the liquid to the mixture tank 45 with power of the liquid feed pump 46 is called “first liquid channel”. The liquid feed pump 46 may not be provided on an input side of the fuel pole 47, but on the output side of the fuel pole 47. The liquid feed valve 31 is not definitely needed.

An output unit of a water recovery tank 55 is connected to a water recovery pump 56. An output unit of the water recovery pump 56 is connected to the mixture tank 45.

A branch is formed between the liquid feed pump 46 and the fuel pole 47 in the first liquid channel. Another channel (pipe, etc.) to reflux a methanol solution to the mixture tank 45 via the branch is provided. This channel is called “second liquid channel”. The second liquid channel is provided only to detect the concentration of methanol in the methanol solution. A liquid feed pump 32 is provided in the second liquid channel. An output unit of the liquid feed pump 32 is connected to the mixture tank 45 via a concentration sensor 60. The liquid feed pump 32 is not definitely needed.

The concentration sensor 60 is attached at a portion of the channel where the methanol solution (having a temperature of 60° C. or higher) flowing from the first liquid channel to the second liquid channel is cooled and the temperature becomes, for example, below 40° C. For this reason, the concentration sensor 60 does not receive a bad influence caused by heat.

In addition, the amount of the methanol solution required to detect the concentration of methanol by the concentration sensor 60 has only to be small (to a negligible degree as compared with the entire methanol solution used in the power generation unit 40). In other words, an inner diameter of the second liquid channel is much smaller than an inner diameter of the first liquid channel and a much small amount of the methanol solution flows into the second liquid channel. Thus, the amount of the methanol solution does not give a bad influence to feed of the fuel to the DMFC stack 42.

On the other hand, in the gas channel, a gas feed pump 50 is connected to a gas pole 52 of the DMFC stack 42 via a gas feed valve 51. An output unit of the gas pole 52 is connected to a condenser 53. The mixture tank 45 is also connected to the condenser 53 via a mixture tank valve 48. The condenser 53 is connected to an exhaust port 58 via an exhaust valve 57. The condenser 53 comprises a fin which effectively condenses steam. A cooling fan 54 is arranged in the vicinity of the condenser 53.

Next, a power generation mechanism of the power generation unit 40 of the fuel cell unit 10 will be explained in accordance with flow of the fuel and gas (oxygen).

First, high-concentration methanol in the fuel cartridge 43 flows into the mixture tank 45 by the fuel feed pump 44. In the mixture tank 45, high-concentration methanol is diluted by mixture with recovered water or low-concentration methanol (residue from the power generation reaction) flowing from the fuel pole 47, and low-concentration methanol is thereby generated. The concentration of low-concentration methanol is controlled to maintain a high efficiency of power generation (for example, 3-6%). The concentration control is implemented by controlling the amount of high-concentration methanol from the fuel feed pump 44 to the mixture tank 45 by the fuel cell control unit 41, on the basis of, for example, a detection result of the concentration sensor 60. Otherwise, the concentration control can be implemented by controlling the amount of water refluxing into the mixture tank 45 by the water recovery pump 56 or the like.

In addition, the mixture tank 45 is equipped with a liquid amount sensor 61 which detects the amount of the methanol solution in the mixture tank 45 and a temperature sensor 64 which detects the temperature of the methanol solution. The fuel cartridge 43 is also equipped with a liquid amount sensor 43a. Detection results of the sensors are transmitted to the fuel cell control unit 41 and used for control of the power generation unit 40 and the like.

The methanol solution diluted in the mixture tank 45 is pressurized by the liquid feed pump 46 and injected into the fuel pole (negative pole) 47 of the DMFC stack 42. At the fuel pole 47, electrons are generated by a reaction of oxidizing methanol. Hydrogen ions (H+) generated by the oxidation reach the gas pole (positive pole) 52 through a solid polymeric electrolyte film 422 provided in the DMFC stack 42.

CO₂ generated by the oxidation in the fuel pole 47 refluxes again to the mixture tank 45 together with the methanol solution which is not subjected to the reaction. CO₂ is vaporized in the mixture tank 45, fed to the condenser 53 via the mixture tank valve 48, and finally exhausted to the outside from the exhaust port 58 via the exhaust valve 57.

On the other hand, gas (oxygen) is taken from an intake port 49, pressurized by the gas feed pump 50, and injected to the gas pole (positive pole) 52 via the gas feed valve 51. At the gas pole 52, reduction of oxygen (O₂) proceeds such that water (H₂O) is generated from electrons (e⁻) coming from outside load, hydrogen ions (H⁺) coming from the fuel pole 47 and oxygen (O₂) as steam. The steam is exhausted from the gas pole 52 and fed to the condenser 53. In the condenser 53, the steam is cooled to become water (liquid) by the cooling fan 54. Water is temporarily stored in the water recovery tank 55. The recovered water refluxes to the mixture tank 45 by the water recovery pump 56. The dilution and circulation system 62 to dilute high-concentration methanol is thus formed.

As understood from the power generation mechanism of the fuel cell unit 10 employing the dilution and circulation system 62, the auxiliary machine 63 for the pumps 44, 46, 50, 56, the valves 48, 51, 57, the cooling fan 54, etc. is driven to start power generation. The methanol solution and gas (oxygen) are thereby injected into the DMFC stack 42 where electric power can be obtained by a proceeding of the electrochemical reaction. To stop the power generation, driving the auxiliary machine 63 is stopped.

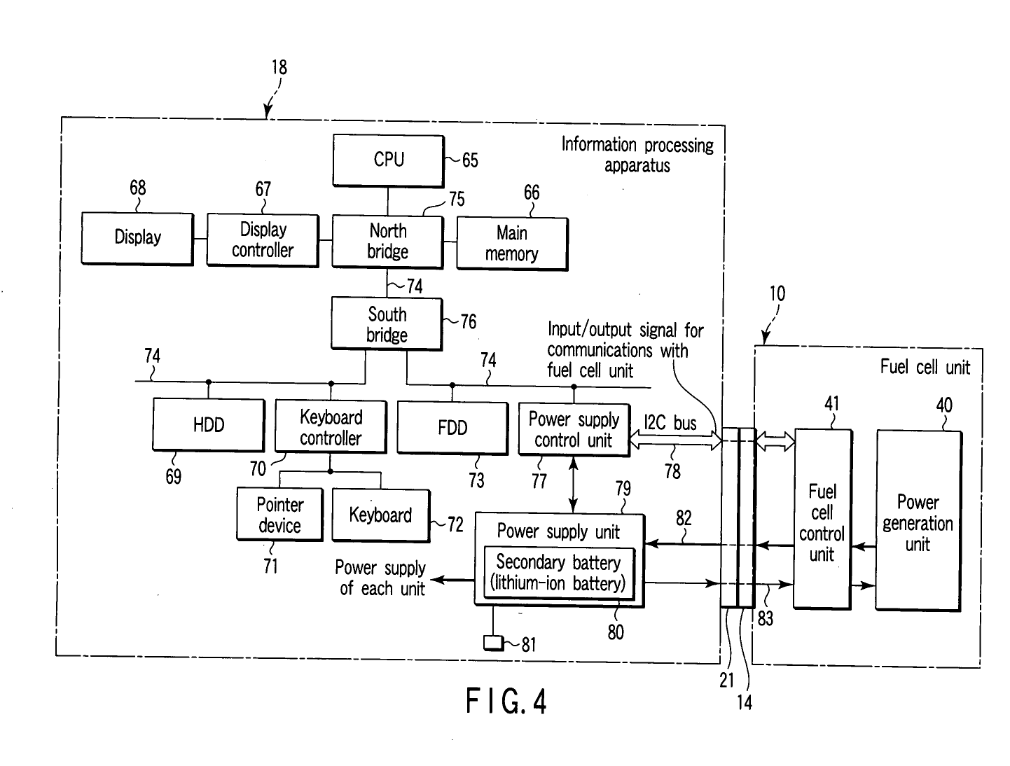

FIG. 4 shows a configuration of a system of the information processing apparatus 18 to be connected to the fuel cell unit 10 according to the present invention.

The information processing apparatus 18 is composed of devices such as a CPU 65, a main memory 66, a display controller 67, a display 68, a HDD (Hard Disk Drive) 69, a keyboard controller 70, a pointer device 71, a keyboard 72, a FDD 73, a bus 74 which transmits a signal among these components, and a north bridge 75 and a south bridge 76 which convert the signal transmitted via the bus 74. In addition, the information processing apparatus 18 includes a power supply unit 79, which holds, for example, a lithium-ion battery as a secondary battery 80. The power supply unit 79 is controlled by a control unit 77 (hereinafter called power supply control unit 77).

A control interface and a power supply interface are provided as electric interfaces for the fuel cell unit 10 and the information processing apparatus 18. The control interface is provided to carry out communications between the power supply control unit 77 of the information processing apparatus 18 and the control unit 41 of the fuel cell unit 10. The communications between the information processing apparatus 18 and the fuel cell unit 10 via the control interface are carried out through, for example, a serial bus such as an I2C bus 78.

The power supply interface is provided to supply and receive the electric power between the fuel cell unit 10 and the information processing apparatus 18. For example, the electric power generated by the DMFC stack 42 of the power generation unit 40 is supplied to the information processing apparatus 18 via the control unit 41 (hereinafter called fuel cell control unit 41) and the docking connectors 14, 21. The power supply interface includes a power supply 83 which supplies the electric power from the power supply unit 79 of the information processing apparatus 18 to the auxiliary machine 63 or the like provided in the fuel cell unit 10.

An AC/DC-converted DC power can be supplied to the power supply unit 79 of the information processing apparatus 18 via a connector 81 for an AC adaptor, for operations of the information processing apparatus 18 and charging of the secondary battery (lithium-ion battery) 80.

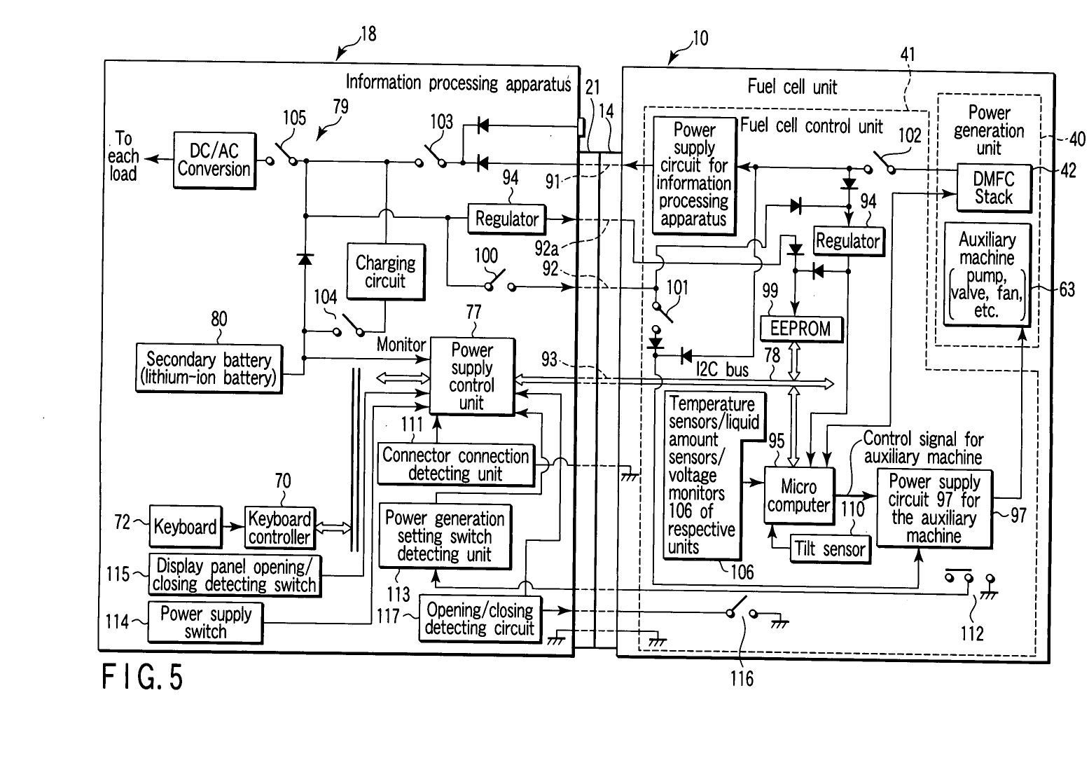

FIG. 5 shows a connection between the fuel cell control unit 41 of the fuel cell unit 10 and the power supply unit 79 of the information processing apparatus 18.

The fuel cell unit 10 and the information processing apparatus 18 are connected mechanically and electrically by the docking connectors 14, 21. The docking connectors 14, 21 comprise a first power supply terminal (output power supply terminal) 91 which supplies the electric power generated by the DMFC stack 42 of the fuel cell unit 10 to the information processing apparatus 18, a second power supply terminal (input power supply terminal for the auxiliary machine) 92 which supplies the electric power from the information processing apparatus 18 to a microcomputer 95 of the fuel cell unit 10 via a regulator 94 and which supplies the electric power to a power supply circuit 97 for the auxiliary machine via a switch 101. In addition, the docking connectors 14, 21 also comprise a third power supply terminal 92a which supplies the electric power from the information processing apparatus 18 to a nonvolatile memory (EEPROM) 99.

Moreover, the docking connectors 14, 21 comprise an input and output terminal 93 for communication, to carry out communications between the power supply control unit 77 of the information processing apparatus 18 and the microcomputer 95 of the fuel cell unit 10 and communications between the power supply control unit 77 and the rewritable EEPROM 99.

The fuel cell control unit 41 comprises a tilt sensor 110 which detects tilt of the fuel cell unit body 12 and sends a detection result to the microcomputer 95, and temperature sensors/liquid amount sensors/voltage monitors 106 of respective units which detect the voltage and number of revolutions of the liquid feed pump 46 and the gas feed pump 50, the liquid feed time, the temperature and liquid amount of each unit, etc. and send detection results to the microcomputer 95.

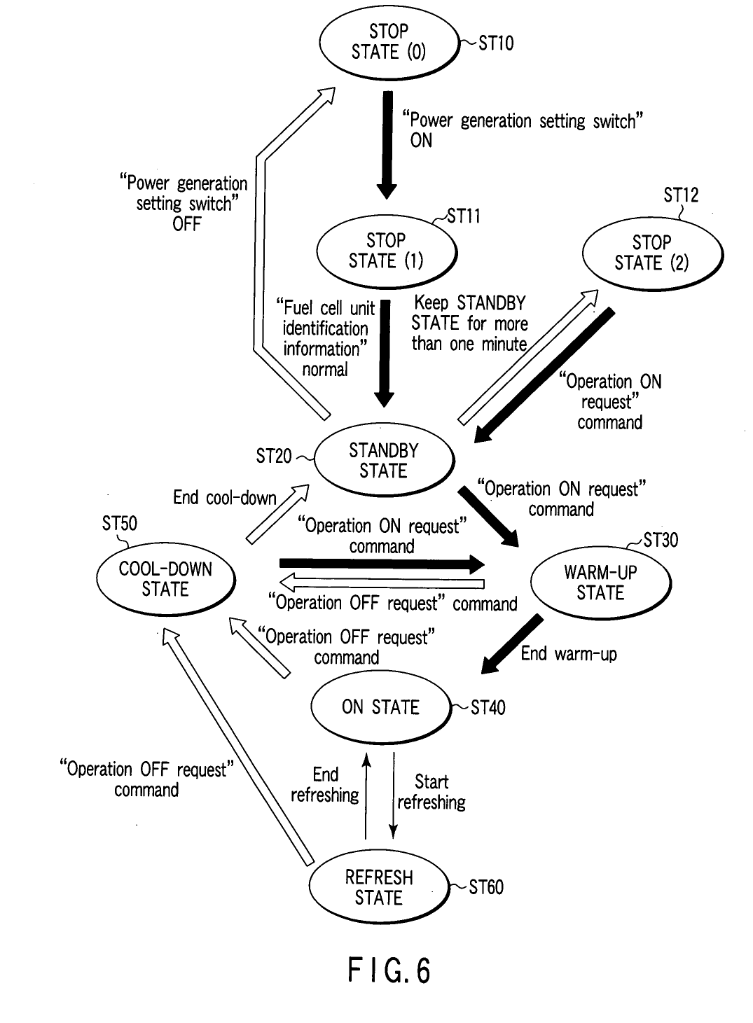

Next, a basic flow of feeding the electric power of the DMFC stack 42 provided in the fuel cell unit 10 from the fuel cell unit 10 to the information processing apparatus 18 will be explained with reference to FIG. 5 showing the connection and FIG. 6 showing the state transition of the fuel cell unit 10.

It is assumed that the secondary battery (lithium-ion battery) 80 of the information processing apparatus 18 is charged with a predetermined electric power and that all of the switches in FIG. 5 are opened.

First, the information processing apparatus 18 confirms that the information processing apparatus 18 and the fuel cell unit 10 are connected mechanically and electrically, on the basis of a signal output from a connector connection detecting unit 111. The confirmation is executed by detecting that the connector connection detecting unit 111 is grounded inside the fuel cell unit 10 by the connection of the docking connectors 14, 21, for example, on the basis of a signal input to the connector connection detecting unit 111.

The power supply control unit 77 of the information processing apparatus 18 confirms whether a power generation setting switch 112 of the fuel cell unit 10 is set to permit the power generation or prohibit the power generation. For example, on the basis of a signal input to a power generation setting switch detecting unit 113, the power generation setting switch detecting unit 113 detects whether the power generation setting switch 112 is in a grounded state or an opened state in accordance with the setting condition of the power generation setting switch 112. If the power generation setting switch 112 is in the opened state, the power supply control unit 77 confirms that the power generation setting switch 112 is set to prohibit the power generation.

The state in which the power generation setting switch 112 is set to prohibit the power generation is represented as “STOP STATE (0)” ST10 in FIG. 6.

If the information processing apparatus 18 and the fuel cell unit 10 are mechanically connected through the docking connectors 14, 21, the electric power is supplied from the information processing apparatus 18 side to the nonvolatile memory (EEPROM) 99 serving as the memory unit of the fuel cell control unit 41 via the third power supply terminal 92a. Identification information of the fuel cell unit 10, identification information of the fuel cartridge 43, attachment history information, feed liquid amount information, and the like are prestored in the EEPROM 99. For example, information items such as component codes, manufacturing serial number, nominal output, and tank capacity information of the fuel cartridge 43, can be included in the identification information. The EEPROM 99 is connected to, for example, the serial bus such as the I2C bus 78. The data stored in the EEPROM 99 can be read in a state in which the electric power is supplied to the EEPROM 99. In the configuration of FIG. 5, the information in the EEPROM 99 can be read by via the input and output terminal 93 the power supply control unit 77.

In this state, electric power is not generated in the fuel cell unit 10. No electric power other than that of the EEPROM 99 is supplied in the fuel cell unit 10. The indicator lamp 85 is turned off.

If the user sets the power generation setting switch 112 to permit power generation (while the power generation setting switch 112 is set in the grounded state in FIG. 5), the identification information stored in the EEPROM 99 provided in the fuel cell unit 10 can be read by the power supply control unit 77 provided in the information processing apparatus 18. This state is represented as “STOP STATE (1)” ST11 in FIG. 6.

In other words, fuel cell unit 10 is in the “STOP STATE (0)” ST10 and generation of electric power in the fuel cell unit 10 can be prohibited as long as the user does not set the power generation setting switch 112 to permit power generation, i.e. the power generation setting switch 112 is set to prohibit power generation.

It is preferable that the power generation setting switch 112 should be, for example, a slide switch which can keep any one of the opened and closed states.

Reading the identification information by the power supply control unit 77 is executed by reading the identification information of the fuel cell unit 10 stored in the EEPROM 99 provided in the fuel cell unit 10 via the serial bus such as the I2C bus 78.

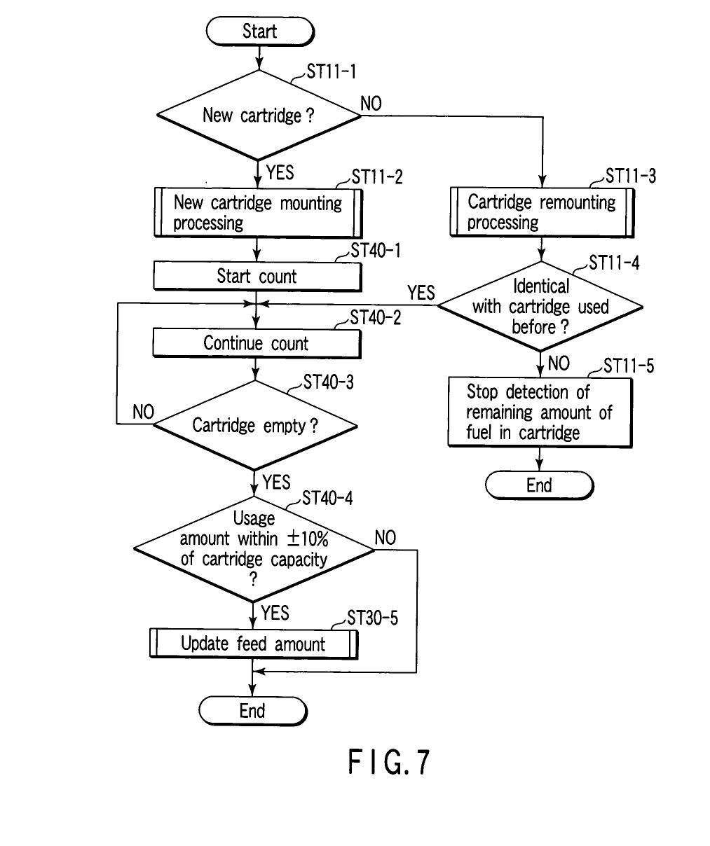

In the state of the “STOP STATE (1)” ST11, if the power supply control unit 77 determines that the fuel cell unit 10 connected to the information processing apparatus 18 is a fuel cell unit suitable for the information processing apparatus 18, on the basis of the identification information of the fuel cell unit 10, the power supply control unit 77 reads the identification information of the fuel cartridge 43 stored in the EEPROM 99 and executes the processing to detect the remaining amount of the fuel in the fuel cartridge 43. The processing of detecting the remaining amount will be explained with reference to the flowchart of FIG. 7.

In the detection of the remaining amount, correction processing is executed by considering the difference in the individual liquid feed pump 32 serving as the auxiliary machine 63 of the fuel cell unit 10, reduction in the amount of the fed liquid caused by degradation of the liquid feed pump 32, difference in the inner pressure at the operation of the mixture tank 45 (which influences the capacity of the pump), difference in the fuel consumption (which varies due to the difference in the concentration sensor 60 and the difference in the stack) and the like. The amount of the fed liquid can be thereby varied.

If the microcomputer 95 of the fuel cell unit 10 discriminates in step ST11-1 that the mounted fuel cartridge 43 is a new cartridge (new product), the microcomputer 95 determines the fuel cartridge 43 as the processing of mounting a new cartridge in step ST11-2 and shifts to a next step, i.e. a count processing of detecting the remaining amount of fuel (to be explained later). Discriminating whether or not the mounted fuel cartridge 43 is a new product is executed when the fuel cartridge 43 is full of the fuel and when it is discriminated on the basis of the identification information of the fuel cell unit 10 stored in the EEPROM 99 that the fuel cartridge 43 has not been mounted before. The discrimination may be executed by referring to the mounting history information of the fuel cartridge 43 stored in the EEPROM 99. Moreover, code data changed once it is used may be stored in the EEPROM 99, and code data may be overwritten with the used code data when the fuel cartridge 43 is first mounted.

If it is discriminated in step ST11-1 by the microcomputer 95 that the mounted fuel cartridge 43 is not a new cartridge, the microcomputer 95 determines the mounted fuel cartridge 43 as a cartridge remounting processing in step ST11-3. If it is discriminated in step ST11-4 that the mounted fuel cartridge 43 has not been used before, the processing of detecting the remaining amount of the fuel in the cartridge is not executed in step ST11-5. In other words, it is discriminated that the remaining amount of fuel cannot be exactly detected since a fuel cartridge which has been used in the other apparatus has no data about a period of previous use.

If it is discriminated in step ST11-4 by the microcomputer 95 that the mounted fuel cartridge 43 has been used before, the processing shifts to a next step, i.e. a count processing of detecting the remaining amount of fuel (to be explained later).

When it is discriminated in step ST11-4 whether or not the mounted fuel cartridge 43 has been used before, it is discriminated whether the mounted fuel cartridge 43 is identical with a fuel cartridge which has been used before, on the basis of the identification information of the fuel cartridge 43, and it is also discriminated whether or not the mounted fuel cartridge 43 has been used before and used for the other information processing apparatus, by referring to the mounting history information of the fuel cartridge 43 stored in the EEPROM 99 (if the mounted fuel cartridge 43 has been used for the other information processing apparatus, the processing shifts to step ST11-5).

The above-described steps ST11-1 to ST11-5 may not be executed in the state of STOP STATE (ST11), but also executed in any of states STANDBY STATE (ST20), WARM-UP STATE (ST30), ON STATE (ST40), COOL-DOWN STATE (ST50) and REFRESH STATE (ST60).

After the above-described processings, the processing of the microcomputer 95 shifts from the “STOP STATE (1)” ST11 to the “STANDBY STATE” ST20.

More specifically, the power supply control unit 77 provided in the information processing apparatus 18 supplies the electric power of the secondary battery 80 to the fuel cell unit 10 via the second power supply terminal 92 and to the microcomputer 95 via the regulator 94.

In the “STANDBY STATE” ST20, the switch 101 provided in the fuel cell unit 10 is opened and the electric power is not supplied to the power supply circuit 97 for the auxiliary machine. Therefore, the auxiliary machine 63 is not operated in this state.

However, the microcomputer 95 starts its operation and is capable of receiving various kinds of control commands from the power supply control unit 77 provided in the information processing apparatus 18 via the I2C bus 78. In addition, the microcomputer 95 is capable of transmitting the power supply information of the fuel cell unit 10 to the information processing apparatus 18 via the I2C bus 78. In this state, for example, the indicator lamp 85 emits a green light representing the normal operation. Otherwise, the indicator lamp 85 may emit the light when supply of the electric power from the fuel cell unit 10 to be explained later is started (WARM-UP STATE ST30) or the output reaches a nominal value (ON STATE ST40).

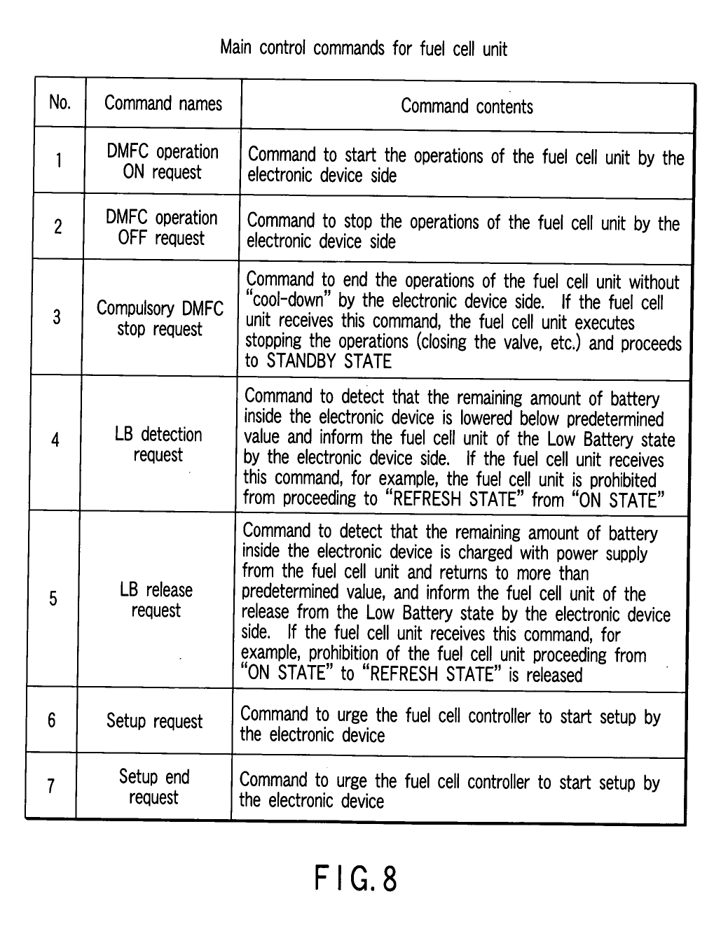

FIG. 8 is a table which shows examples of control commands transmitted from the power supply control unit 77 provided in the information processing apparatus 18 to the microcomputer 95 provided in the fuel cell control unit 41.

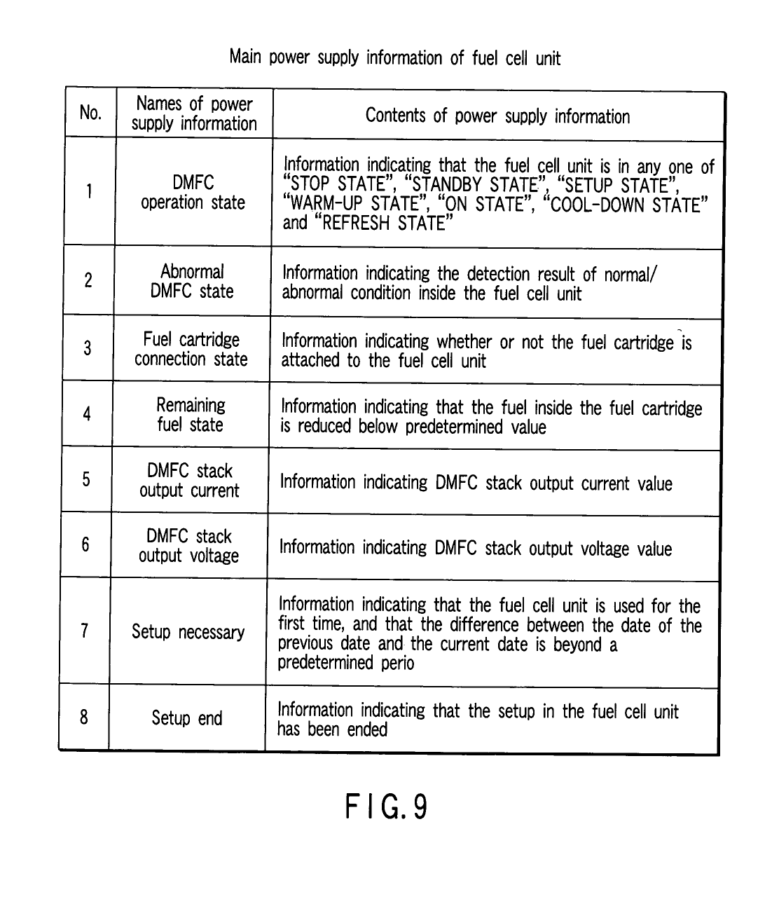

FIG. 9 is a table which shows examples of power supply information items transmitted from the microcomputer 95 provided in the fuel cell control unit 41 to the power supply control unit 77 provided in the information processing apparatus 18.

The power supply control unit 77 provided in the information processing apparatus 18 determines that the fuel cell unit 10 is in the “STANDBY STATE” ST20 by reading “DMFC operation state” (No. 1), of the power supply information items of FIG. 9.

If the power supply control unit 77 transmits a “DMFC operation ON request” command (power generation start command), of the control commands shown in FIG. 8, in the state of “STANDBY STATE” ST20, the fuel cell control unit 41 which receives the command shifts the state of the fuel cell unit 10 to “WARM-UP STATE” ST30.

More specifically, the switch 101 provided in the fuel cell control unit 41 is closed and the electric power is supplied from the information processing apparatus 18 to the power supply circuit 97 for the auxiliary machine, under control of the microcomputer 95. Simultaneously, the auxiliary machine 63 provided in the power generation unit 40, i.e. the pumps 44, 46, 50, 56, the valves 48, 51, 57 and the cooling fan 54 shown in FIG. 4 are driven by the auxiliary machine control signal transmitted from the microcomputer 95. Furthermore, the microcomputer 95 closes a switch 102 provided in the fuel cell control unit 41.

As a result, the methanol solution and gas are injected into the DMFC stack 42 provided in the power generation unit 40 and power generation is thereby started. The electric power generated by the DMFC stack 42 is supplied to the information processing apparatus 18. However, the state in which the power output is reaching the nominal value is called “WARM-UP STATE” ST30 since the power output does not instantaneously reach the nominal value.

When the state of the fuel cell unit 10 shifts to “WARM-UP STATE” ST30, the count processing, i.e. detection of the remaining amount of fuel in the fuel cartridge 43 is started.

The “count processing” is to monitor and count the fuel feed amount, i.e. the number of revolutions and number of shots of the feed pump 32, which are different in accordance with the kind of pumps, if the fuel is fed from the fuel cartridge 43 to the mixture tank 45 by the feed pump 32.

If the microcomputer 95 of the fuel cell unit 10 detects the new cartridge mounting processing in step ST11-2, the microcomputer 95 starts count of the feed pump 32 in step ST30-1, as shown in FIG. 7. The microcomputer 95 continues the count in step ST30-2.

If it is discriminated that the mounted cartridge has been use before, in step ST11-4, the microcomputer 95 directly shifts to step ST30-2 and continues the count without newly starting the count.

The count processing is explained here in detail.

The count processing executed in “WARM-UP STATE” ST30 (or ON STATE ST40) is different in accordance with the kind of the feed pump 32.

For example, if the feed pump 32 is a solenoid pump, the following equation is applied to the count processing. 1 SHOT of the solenoid pump is defined as one unit.
Feed amount per unit=(Capacity of the fuel cartridge)/(Number of times of SHOT: Number of the count)

If the feed pump 32 is a revolution-type pump, the following equation is applied to the count processing. One revolution of the pump is defined as one unit.
Feed amount per unit=(Capacity of the fuel cartridge)/(Feed time)/(Average number of revolutions: Number of the count)

The information employed by the equations is obtained from the capacity information, etc. of the fuel cartridge stored in the temperature sensors/liquid amount sensors/voltage monitors 106 of respective units and the EEPROM 99 provided in the fuel cell unit 10.

If the average amount of the fuel fed by the feed pump 32 is obtained in the above-explained manners, the usage amount of the fuel is obtained in the following equations.

In the case of the solenoid pump:
Usage amount of the fuel=Number of counts*Feed amount per unit

In the case of the revolution-type pump:
Usage amount of the fuel=Feed time*Average number of revolutions*Feed amount per unit

If the microcomputer 95 discriminates that the feed pump 32 is empty, on the basis of the information received from the liquid amount sensor 43a, in step ST30-3 (or ON STATE ST40-3), and discriminates that the obtained “usage amount of the fuel” falls within ±10% of the capacity of the cartridge 43, in step ST30-4 (ON STATE ST40-4), the microcomputer 95 updates the fuel feed amount information stored in the EEPROM 99 of the fuel cell unit 10 with the “average feed amount” obtained in the above-explained equation.

In step ST30-3 (or ON STATE ST40-3), the microcomputer 95 discriminates that the obtained “usage amount of the fuel” falls within ±10% of the capacity of the cartridge 43, in order to prevent the feed amount from being erroneously updated (or corrected) in a case where the period in which the fuel cartridge 43 becomes empty is extremely short or long.

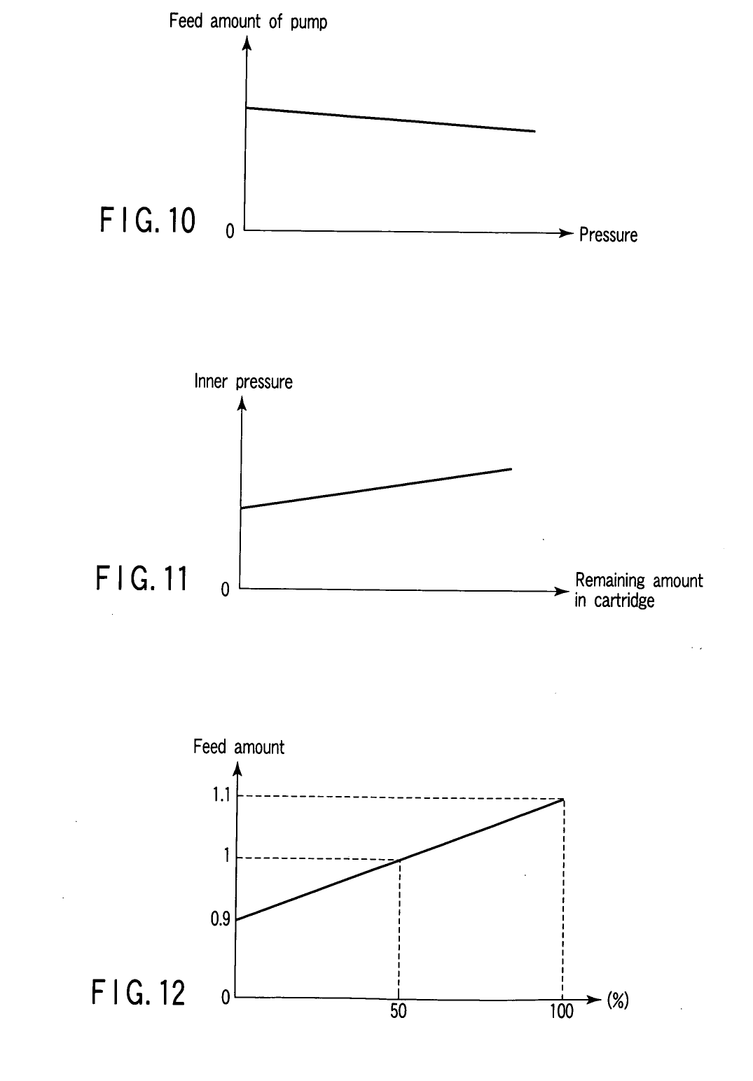

In general, the feed amount is varied due to the pressure, in the feed pump 32, as shown in FIG. 10.

In addition, the inner pressure is varied due to the remaining amount of the fuel, in the feed pump 32, as shown in FIG. 11.

If these variations cannot be neglected, the following processing corresponding to the difference in the fuel cartridge 43 can be executed besides the above-described correction.

FIG. 12 shows an example of correcting the characteristic of the fuel cartridge 43.

For example, the following equation is employed to obtain a corrected value of the characteristic of the fuel cartridge 43.
Corrected value of the characteristic of the fuel cartridge={1+((remaining amount)−50)/500}

This equation corresponds to FIG. 12. The remaining amount is set at 100 if the fuel cartridge 43 is full of fuel or 0 if the fuel cartridge 43 is empty.

When the corrected value of the characteristic of the fuel cartridge 43 is obtained, a corrected feed amount of the fuel cartridge 43 can be obtained in the following equation.
Corrected feed amount=(Average feed amount)*(Corrected value of the characteristic of the fuel cartridge)

Use of the (corrected feed amount) thus obtained can be applied to the difference in the fuel cartridge 43.

In the “WARM-UP STATE” ST 30, the microcomputer 95 provided in the fuel cell control unit 41 monitors, for example, the output voltage and the temperature of the DMFC stack 42. If the microcomputer 95 discriminates that the output of the DMFC stack 42 has reached the nominal value, the microcomputer 95 opens the switch 101 provided in the fuel cell unit 10 and switches the information processing apparatus 18 to the DMFC stack 42 as the power supply source for the auxiliary machine 63. This state is the “ON STATE” ST40.

Described above is the summary of the flow of the processing from the “STOP STATE” ST10 to the “ON STATE” ST40.

According to an embodiment, the remaining amount of fuel can be detected without troubles.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell unit comprising:
a fuel cell;
fuel containing means for containing a fuel;
a mixture tank in which water obtained by condensing steam fed from the fuel cell and the fuel fed from the fuel containing means are mixed and a fuel solution to be supplied to the fuel cell is generated;
storage means for storing first feed amount information of the fuel fed from the fuel containing means to the mixture tank;
fuel feeding means for feeding the fuel from the fuel containing means to the mixture tank, on the basis of the first feed amount information;
measuring means connected to the fuel feeding means, for measuring a feed operation amount of the fuel feeding means until the fuel is out;
a first channel which refluxes the fuel solution between the mixture tank and the fuel cell;
a control unit for calculating remaining amount information of the fuel in the fuel feeding means and second feed amount information on the basis of the feed operation amount obtained from a measurement result of the measuring means; and
a controller for updating the first feed amount information stored in the storage means with the second feed information.

2. The fuel cell unit according to claim 1, further comprising:
an auxiliary machine provided in the first channel, for controlling a flow of the fuel solution in the first channel;
a second channel which refluxes the fuel solution fed from the mixture tank to the mixture tank via a branch in the first channel; and
a concentration sensor provided in the second channel, for detecting a fuel concentration of the fuel solution in the second channel,
wherein the fuel concentration obtained from a detection result of the concentration sensor represents a predetermined state, the control unit changes a flow of the fuel solution in the second channel by controlling an operation of the auxiliary machine.

3. The fuel cell unit according to claim 1, wherein an amount sensor is connected to the fuel containing means,
inherent identification information corresponding to the fuel containing means is stored in the storage means, and
in a case where the fuel containing means is mounted, if the control unit discriminates that the mounted fuel containing means is suitable on the basis of the amount sensor and the identification information, the controller urges the measuring means to start measuring the feed operation amount.

4. The fuel cell unit according to claim 1, wherein the feed operation amount indicates number of revolutions or number of shots of a feed pump serving as the fuel supplying means, and
the controller executes control based on the second feed amount by varying the number of revolutions or the number of shots of the fuel supplying means.

5. The fuel cell unit according to claim 1, wherein when the controller calculates the second feed amount information and the remaining amount information of the fuel, the controller compares a usage amount of the fuel calculated on the basis of the second feed amount information with a capacity of the fuel feeding means,
if an error exceeds a predetermined range, the controller uses the first feed amount information stored in the storage means instead of the second feed amount information.

6. A method of calculating a remaining amount of a fuel in a fuel cell unit comprising a mixture tank in which water obtained by condensing steam fed from a fuel cell and a fuel are mixed and a fuel solution to be supplied to the fuel cell is generated, fuel containing means for containing the fuel, fuel feeding means for feeding the fuel from the fuel containing means to the mixture tank, measuring means connected to the fuel feeding means, and a controller for controlling the fuel feeding means,
the method comprising:
measuring a feed operation amount of the fuel feeding means by the measuring means until the fuel is out; and
calculating remaining amount information of the fuel in the fuel feeding means on the basis of the measured feed operation amount, by the controller.

7. The method according to claim 6, wherein the fuel cell unit further comprises an auxiliary machine provided in the first channel, for controlling a flow of the fuel solution in the first channel, a second channel which refluxes the fuel solution fed from the mixture tank to the mixture tank via a branch in the first channel, and a concentration sensor provided in the second channel, for detecting a fuel concentration of the fuel solution in the second channel,
wherein the fuel concentration obtained from a detection result of the concentration sensor represents a predetermined state, the control unit changes a flow of the fuel solution in the second channel by controlling an operation of the auxiliary machine.

8. The method according to claim 6, wherein an amount sensor is connected to the fuel containing means,
inherent identification information corresponding to the fuel containing means is stored in the storage means, and
in a case where the fuel containing means is mounted, if the control unit discriminates that the mounted fuel containing means is suitable on the basis of the amount sensor and the identification information, the controller urges the measuring means to start measuring the feed operation amount.

9. The method according to claim 6, wherein the feed operation amount indicates at least on number of revolutions and number of shots of a feed pump serving as the fuel supplying means, and
the controller executes control based on the second feed amount by varying the number of revolutions or the number of shots of the fuel supplying means.

10. The method according to claim 6, wherein when the controller calculates the second feed amount information and the remaining amount information of the fuel, the controller compares a usage amount of the fuel calculated on the basis of the second feed amount information with a capacity of the fuel feeding means,
if an error exceeds a predetermined range, the controller uses the first feed amount information stored in the storage means instead of the second feed amount information.
